(19) United States
(12) Patent Application Publication
(10) Pub. No.: US 2025/0306240 A1
(43) Pub. Date: Oct. 2, 2025

(54) IMPLEMENTING DISASTER RECOVERY BASED ON WEATHER FORECASTING DATA

(71) Applicant: International Business Machines Corporation, Armonk, NY (US)

(72) Inventors: Shyamal Kuhar Saha, London (GB); Amit Deshpande, Pune (IN); Vishal Anand, Dublin (IE); Utpal Mangla, Toronto (CA)

(21) Appl. No.: 18/624,330

(22) Filed: Apr. 2, 2024

(51) Int. Cl. G01W 1/10

(52) U.S. Cl. CPC G01W 1/10

(57) ABSTRACT

Described are techniques for implementing disaster recovery. Weather forecasting data (e.g., prediction of temperature, wind speed, wind direction, etc.) for a first location (e.g., data center) is received. A prediction of the likelihood of the future severe weather event occurring at the first location where a workload is running that necessitates disaster recovery is generated based on the received weather forecasting data using a model trained to predict the likelihood of future severe weather events occurring at the first location using weather forecasting data. A determination is then made as to whether to implement disaster recovery, which involves the transfer of the processing of the workload performed at the first location to a second location based on such a prediction. For example, such a prediction, which may correspond to a value, is compared to a threshold value, in order to determine whether to implement disaster recovery.

### TECHNICAL FIELD

The present disclosure relates generally to disaster recovery.

### BACKGROUND

Disaster recovery is the process by which an organization anticipates and addresses technology-related disasters. For example, disaster recovery is the process of preparing for and recovering from any event that prevents a workload or system from fulfilling its business objectives in its primary deployed location, such as power outages, or natural events (e.g., storms, hurricanes, heat waves, etc.).

### SUMMARY

In one embodiment of the present disclosure, a computer-implemented method for implementing disaster recovery comprises receiving weather forecasting data pertaining to a first location. The method further comprises generating a prediction of a likelihood of a future severe weather event occurring at the first location where a workload is running that necessitates disaster recovery based on the received weather forecasting data using a model trained to predict future severe weather events at the first location. The method additionally comprises determining whether to transfer processing of the workload from the first location to a second location based on the prediction.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the disaster recovery system for implementing disaster recovery using weather forecasting data in accordance with an embodiment of the present disclosure;

FIG. 3 illustrates an embodiment of the present disclosure of the hardware configuration of the disaster recovery system which is representative of a hardware environment for practicing the present disclosure;

FIG. 4 is a flowchart of a method for training a model for predicting the likelihood of a future severe weather event occurring at a location where a workload is running that necessitates disaster recovery in accordance with an embodiment of the present disclosure;

FIG. 5 is a flowchart of a method for training a generative artificial intelligence model for generating a runbook providing instructions for transferring the processing of the workload from one location to another location in accordance with an embodiment of the present disclosure; and

FIG. 6 is a flowchart of a method for implementing disaster recovery proactively by using weather forecasting data in accordance with an embodiment of the present disclosure.

### DETAILED DESCRIPTION

As stated above, disaster recovery is the process by which an organization anticipates and addresses technology-related disasters. For example, disaster recovery is the process of preparing for and recovering from any event that prevents a workload or system from fulfilling its business objectives in its primary deployed location, such as power outages, or natural events (e.g., storms, hurricanes, heat waves, etc.).

A plan, referred to as a “disaster recovery plan,” helps organizations respond promptly to disruptive events and provides key benefits. For example, such a disaster recovery plan ensures business continuity. When a disaster strikes, it can be detrimental to all aspects of the business and is often costly. It also interrupts normal business operations, as the team's productivity is reduced due to limited access to tools they require to work.

Currently, such disaster recovery plans focus on reacting to disaster events, such as power outages and natural events (e.g., storms, hurricanes, heat waves, etc.). For example, once such a disaster event occurs, then a plan is enacted, such as backing up the workload being processed by the data center affected by the disaster event. Unfortunately, by being reactive, data may be lost at the data center subject to the disaster event prior to backing up such data. In such an approach, the recovery time objective is very high. The recovery time objective is a metric that determines the maximum amount of time that passes before disaster recovery is completed. Furthermore, in such an approach, the recovery point objective is very high. The recovery point objective is the maximum amount of time acceptable for data loss after a disaster.

Alternatively, a disaster recovery plan may focus on replicating the data center as well as the workloads running at such a data center. When one of these data centers is subject to a disaster event, the other data center may still be operational and continue to process the workloads. However, such an architecture (replicating workloads at a second data center) is extremely expensive to implement.

Unfortunately, such current approaches to disaster recovery are reactive (i.e., in response to the disaster event which may result in the loss of data) or expensive to implement.

The embodiments of the present disclosure provide a means for more effectively implementing disaster recovery due to unforeseen circumstances, such as natural calamities (e.g., hurricanes, tornados, heat waves, etc.), without being reactive to such unforeseen circumstances and in a relatively inexpensive manner. In one embodiment, a model (machine learning model) is trained to predict future severe weather events (e.g., heat wave, storm, hurricane) occurring at a location (e.g., data center where a workload is running) that necessitate disaster recovery based on training data consisting of situations requiring disaster recovery at the location based on weather forecasting data for that location. Disaster recovery, as used herein, is the process of protecting data from disasters, such as a natural disaster (e.g., storm). Weather forecasting data, as used herein, refers to data used to predict what the atmosphere will be like at a particular location at a future time. For example, weather forecasting data includes the prediction of temperature, humidity, wind speed, wind direction, cloud coverage, air pressure, etc. at a particular location (e.g., data center where a workload is running) at a particular future time (e.g., 5 hours from the current time). In this manner, such data is used to predict weather events, including severe weather events, such as torrential storms, hurricanes, heat waves, etc. A “severe weather event,” as used herein, refers to any dangerous meteorological phenomenon with the potential to cause damage, serious disruption, or loss of human life at a location, such as at a data center where a workload is running. Examples of severe weather events can include, but are not limited to, tornados, straight-line winds, flash floods, hailstorms, hurricanes, heat waves, etc. In one embodiment, based on current weather forecasting data at a location (e.g., data center where a workload is running), the trained model discussed above is utilized to generate a prediction of the likelihood of a future severe weather event occurring at the location that necessitates disaster recovery. The prediction, as used herein, refers to a likelihood of a future severe weather event occurring at a particular location (e.g., data center where a workload is running). Such a prediction may correspond to a value, which is compared a threshold value, which may be user-designated. A determination as to whether to implement a disaster recovery plan, such as transferring the processing of the workload from a first location to a second location, based on the prediction is performed. For example, if the prediction exceeds a threshold value, then the location is deemed to be subject to a future severe weather event that necessitates disaster recovery. As a result, the processing of the workload is transferred from the location deemed to be subject to a future severe weather event that necessitates disaster recovery to a second location. In this manner, disaster recovery due to unforeseen circumstances (e.g., tornadoes, flash floods, etc.) is effectively implemented by being proactive as opposed to being reactive to natural calamities (e.g., tornadoes, flash floods, etc.) in a relatively inexpensive manner. A further discussion regarding these and other features is provided below.

In some embodiments of the present disclosure, the present disclosure comprises a computer-implemented method, system, and computer program product for implementing disaster recovery. In one embodiment of the present disclosure, weather forecasting data for a first location (e.g., data center) is received. Weather forecasting data, as used herein, refers to data used to predict what the atmosphere will be like at a particular location (e.g., first location) at a future time. For example, weather forecasting data includes the prediction of temperature, humidity, wind speed, wind direction, cloud coverage, air pressure, etc. at a particular location (e.g., data center where a workload is running) at a particular future time (e.g., 5 hours from the current time). A prediction of the likelihood of the future severe weather event occurring at the first location where a workload is running within a user-designated amount of time (e.g., 3 hours from the current time) that necessitates disaster recovery is generated based on the received weather forecasting data using a model trained to predict future severe weather events occurring at the first location using weather forecasting data. The prediction of the likelihood of a future severe weather event, as used herein, refers to the probability of the future severe weather event occurring at a particular location (e.g., data center where a workload is running). In one embodiment, such a prediction corresponds to a value, such as a number ranging between 0 and 100. A determination is then made as to whether to implement disaster recovery, which involves the transfer of the processing of the workload performed at the first location to a second location based on such a prediction. For example, in one embodiment, such a prediction is compared to a threshold value, which may be user-designated. For instance, if the threshold value is 95, then if the prediction corresponds to a value of 96, indicating that there is a 96% chance of a future severe weather event, such as a tornado, occurring at the first location within a user-designated amount of time (e.g., 3 hours), then disaster recovery is implemented, such as transferring the processing of the workload from the first location to the second location. In this manner, disaster recovery is effectively implemented by being proactive (disaster recovery implemented prior to the disaster event actually occurring at the location) as opposed to being reactive to natural calamities (e.g., tornadoes, flash floods, etc.) in a relatively inexpensive manner.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

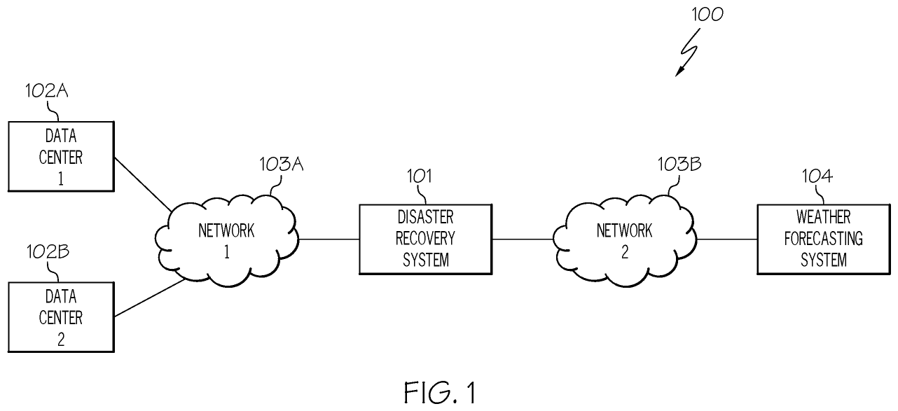

Referring now to the Figures in detail, FIG. 1 illustrates an embodiment of the present disclosure of a communication system 100 for practicing the principles of the present disclosure. Communication system 100 includes a disaster recovery system 101 connected to data centers 102A-102B (identified as “Data Center 1,” and “Data Center 2,” respectively, in FIG. 1) located at different locations (e.g., Data Center 1 is located at a different location than Data Center 2) via a network 103A (identified as “Network 1” in FIG. 1). Furthermore, as illustrated in FIG. 1, disaster recovery system 101 is connected to weather forecasting system 104 via a network 103B (identified as “Network 2” in FIG. 1).

Data Centers 102A-102B may collectively or individually be referred to herein as data centers 102 or data center 102, respectively. A data center 102, as used herein, refers to a physical facility that organizations use to house their critical applications and data. The design of data center 102 is based on a network of computing and storage resources that enable the delivery of shared applications and data. The key components of data center 102 include routers, switches, firewalls, storage systems, servers, and application-delivery controllers.

Networks 103A-103B may collectively or individually be referred to herein as networks 103 or network 103, respectively. Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 902.11 standards network, various combinations thereof, etc. Other networks, whose descriptions are omitted here for brevity, may also be used in conjunction with system 100 of FIG. 1 without departing from the scope of the present disclosure.

While FIG. 1 illustrates multiple networks 103, system 100 may utilize a single network 103 for interconnecting the components of system 100.

Weather forecasting system 104 refers to a system that implements numerical weather prediction, which uses models of the atmosphere and oceans to predict the weather based on current weather conditions. In one embodiment, weather forecasting system 104 utilizes National Oceanic and Atmospheric Administration's (NOAA's) Weather and Climate Operational Supercomputer System (WCOSS) to perform such weather predictions. WCOSS is configured to collect, process, and analyze billions of observations from weather satellites, weather balloons, buoys, and surface stations from around the world in order to perform such weather predictions. For example, current weather conditions at a location, such as the location of data center 102A, may be used by WCOSS of weather forecasting system 104 to predict various weather conditions to occur at a future time at such a location. For instance, WCOSS of weather forecasting system 104 may predict the temperature, precipitation, humidity, wind speed, wind direction, cloud coverage, air pressure, etc. to occur at a future time (e.g., three hours from the current time) at the location of data center 102A. Such predictions correspond to weather forecasting data.

In one embodiment, weather forecasting system 104 utilizes NOAA's Advanced Weather Information Processing System (AWIPS) that weather forecasters, such as at NOAA, use to process, display, and communicate meteorological data to make weather predictions. In one embodiment, the AWIPS utilizes the WCOSS to process data from doppler radar, radiosondes, weather satellites, and other sources using models and forecast guidance products.

In one embodiment, such weather forecasting data is utilized by disaster recovery system 101 to more effectively implement disaster recovery due to unforeseen circumstances, such as natural calamities (e.g., hurricanes, tornados, heat waves, etc.) without being reactive to such unforeseen circumstances and in a relatively inexpensive manner. Weather forecasting data, as used herein, refers to data used to predict what the atmosphere will be like at a particular location (e.g., data center 102A) at a future time. For example, weather forecasting data includes the prediction of temperature, humidity, wind speed, wind direction, cloud coverage, air pressure, etc. at a particular location (e.g., data center 102A where a workload is running) at a particular future time (e.g., 5 hours from the current time).

In one embodiment, disaster recovery system 101 is configured to predict a future severe weather event occurring at a location (e.g., data center 102A) where a workload is running that necessitates disaster recovery based on the weather forecasting data using a model trained to predict future severe weather events occurring at such a location. A “severe weather event,” as used herein, refers to any dangerous meteorological phenomenon with the potential to cause damage, serious disruption, or loss of human life at a location, such as at a data center where a workload is running. Examples of severe weather events can include, but are not limited to, tornados, straight-line winds, flash floods, hailstorms, hurricanes, heat waves, etc. In one embodiment, based on current weather forecasting data (weather forecasting data received from weather forecasting system 104) for a location (e.g., data center 102A where a workload is running), the trained model discussed above is utilized to generate a prediction of the likelihood of a future severe weather event occurring at the location that necessitates disaster recovery. Such a “prediction,” as used herein, refers to a likelihood of a future severe weather event occurring at a particular location (e.g., data center 102A where a workload is running). In one embodiment, such a prediction corresponds to a value.

In one embodiment, disaster recovery system 101 compares the prediction of a future severe weather event occurring at a location with a threshold value, which may be user-designated, to determine if the weather prediction warrants implementing disaster recovery at the location. If the prediction exceeds such a threshold value, then the location is deemed to be subject to a future severe weather event that necessitates disaster recovery. Disaster recovery, as used herein, refers to the process of protecting data from disasters, such as a natural disaster (e.g., tornado). In one embodiment, such a disaster recovery involves transferring the processing of a workload currently being processed at the location subject to a future severe weather event to a different location. In this manner, disaster recovery due to unforeseen circumstances (e.g., tornadoes, flash floods, etc.) may be implemented in an effective manner without any interruption in the processing of the workloads by being proactive as opposed to being reactive to natural calamities (e.g., tornados, flash floods, etc.).

In one embodiment, disaster recovery system 101 implements disaster recovery utilizing a runbook that was generated using generative artificial intelligence. In one embodiment, disaster recovery system 101 trains a generative artificial intelligence model to generate a runbook to be utilized to implement a disaster recovery plan when disaster recovery is determined to be implemented due to the likelihood of a future severe weather event occurring at a location (e.g., data center 102A) exceeding a threshold value. A runbook, as used herein, includes instructions for transferring the processing of a workload from a first location (e.g., data center 102A) to a second location (e.g., data center 102B).

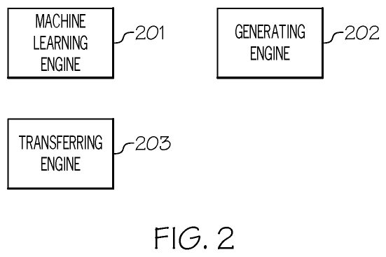

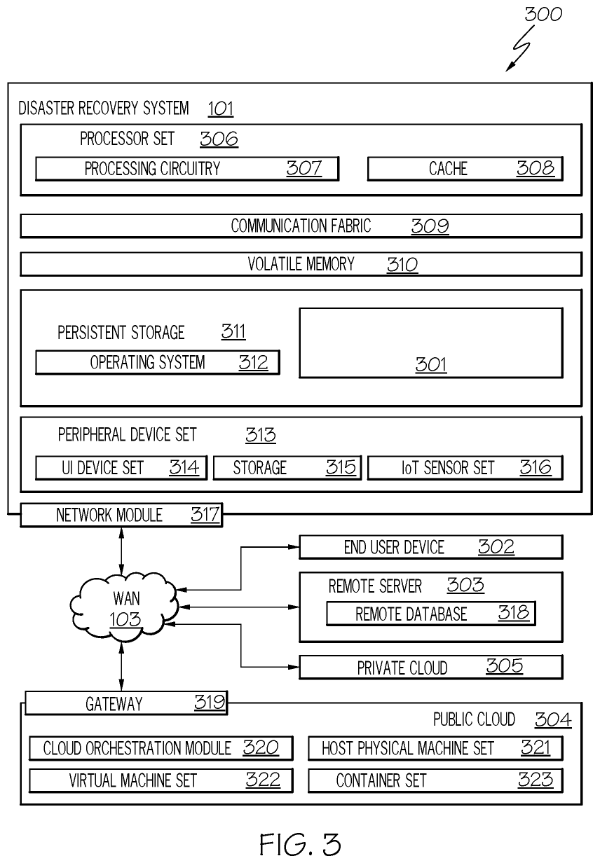

A description of the software components of disaster recovery system 101 used for implementing disaster recovery using weather forecasting data is provided below in connection with FIG. 2. A description of the hardware configuration of disaster recovery system 101 is provided further below in connection with FIG. 3.

System 100 is not to be limited in scope to any one particular network architecture. System 100 may include any number of disaster recovery systems 101, data centers 102, networks 103, and weather forecasting systems 104.

A discussion regarding the software components used by disaster recovery system 101 for implementing disaster recovery using weather forecasting data is provided below in connection with FIG. 2.

FIG. 2 is a diagram of the software components of disaster recovery system 101 (FIG. 1) for implementing disaster recovery using weather forecasting data in accordance with an embodiment of the present disclosure.

Referring to FIG. 2, in conjunction with FIG. 1, disaster recovery system 101 includes machine learning engine 201 configured to build and train a model to predict a future severe weather event occurring at a location (e.g., data center 102A) that necessitates disaster recovery. Disaster recovery, as used herein, is the process of protecting data from disasters, such as a natural disaster (e.g., storm).

A “severe weather event,” as used herein, refers to any dangerous meteorological phenomenon with the potential to cause damage, serious disruption, or loss of human life at a location, such as at a data center where a workload is running. Examples of severe weather events can include, but are not limited to, tornados, straight-line winds, flash floods, hailstorms, hurricanes, heat waves, etc. In one embodiment, based on current weather forecasting data (weather forecasting data received from weather forecasting system 104) for a location (e.g., data center 102A where a workload is running), the model is trained to predict a likelihood of a future severe weather event occurring at the location that necessitates disaster recovery. The prediction of the likelihood of a future severe weather event, as used herein, refers to the probability of the future severe weather event occurring at a particular location (e.g., data center 102A where a workload is running), such as at a user-designated amount of time in the future (e.g., three hours from the current time). In one embodiment, such a prediction corresponds to a value, such as a number ranging between 0 and 100, where the higher the value of the number, the greater the likelihood of a severe weather event occurring at the location, which necessitates disaster recovery.

In one embodiment, machine learning engine 201 builds and trains a model to predict a future severe weather event occurring at a location (e.g., data center 102A) that necessitates disaster recovery based on a sample data set that includes situations requiring disaster recovery at a location based on weather forecasting data for that location. Weather forecasting data, as used herein, refers to data used to predict what the atmosphere will be like at a particular location at a future time. For example, weather forecasting data includes the prediction of temperature, humidity, wind speed, wind direction, cloud coverage, air pressure, etc. at a particular location (e.g., data center 102A where a workload is running) at a particular future time (e.g., 5 hours from the current time).

Such a sample data set may be stored in a data structure (e.g., table) residing within the storage device of disaster recovery system 101. In one embodiment, such a data structure is populated by an expert.

Furthermore, in one embodiment, the sample data set discussed above is referred to herein as the “training data,” which is used by a machine learning algorithm to make predictions or decisions as to the likelihood of a future severe weather event occurring at the location to necessitate disaster recovery. The algorithm iteratively makes predictions on the training data as to the likelihood of a future severe weather event occurring at the location to necessitate disaster recovery until the predictions achieve the desired accuracy as determined by an expert. Examples of such learning algorithms include nearest neighbor, Naïve Bayes, decision trees, linear regression, support vector machines, and neural networks.

Furthermore, in one embodiment, machine learning engine 201 builds and trains a generative artificial intelligence model to generate a runbook providing instructions for transferring the processing of the workload from a first location (e.g., data center 102A) to a second location (e.g., data center 102B). A runbook, as used herein, includes instructions for transferring the processing of a workload from a first location (e.g., data center 102A) to a second location (e.g., data center 102B). For example, in situations in which the likelihood of a future severe weather event occurring at the first location that necessitates disaster recovery exceeds a threshold value, which may be user-designated, a runbook is generated using generative artificial intelligence to provide instructions for transferring the processing of the workload from the first location (e.g., data center 102A) to a second location (e.g., data center 102B).

In one embodiment, such a runbook includes details regarding the migration of the workload from the first location to the second location, such as utilizing on-premise tools if the workload is to be migrated within the network of a medium or large enterprise installation or cloud-based tools if the workload is to be migrated from the first location to the cloud and then to the second location.

In one embodiment, such a runbook includes post-migration testing.

In one embodiment, such a runbook includes a listing of the particular folders (e.g., virtual machines folders) to store data for the workload, which are moved to the new datastore at the new location (e.g., data center).

In one embodiment, such a runbook includes the files, such as OVA (Open Virtual Appliance) and OVF (Open Virtualization Format), pertaining to the workload being processed at the first location to be transferred to the second location.

In one embodiment, machine learning engine 201 builds and trains a generative artificial intelligence model to generate a runbook providing instructions for transferring the processing of the workload from a first location (e.g., data center 102A) to a second location (e.g., data center 102B) based on a sample data set that includes instructions for transferring the processing of various workloads from various locations, including the system architectures (e.g., meshwork, three-tier or multi-tier model, mesh point of delivery, super spine mesh, components, such as switches and servers, etc.) of the data centers at such locations, and backup operation procedures. The architecture of the data center, as used herein, refers to the architectural design that establishes connections between components, such as switches and servers. Backup operation procedures, as used herein, refer to the process of creating and storing copies of data that can be used to protect organizations against data loss. Backup operation procedures ensure that essential data processing operational tasks can be conducted after the disruption, such as a disaster event (e.g., tornado).

In one embodiment, the sample data set discussed above may be stored in a data structure (e.g., table) residing within the storage device of disaster recovery system 101. In one embodiment, such a data structure is populated by an expert.

Upon training the generative artificial intelligence model to generate a runbook providing instructions for transferring the processing of the workload from a first location (e.g., data center 102A) to a second location (e.g., data center 102B), the trained generative artificial intelligence model generates the appropriate runbook based on the workload to be transferred, the architectures of the data centers at the locations, and the backup operation procedures to be implemented. In one embodiment, information pertaining to the workload to be transferred, the architectures of the data centers at the locations, and the backup operation procedures to be implemented are provided by an expert.

Furthermore, in one embodiment, the sample data set discussed above is referred to herein as the “training data,” which is used by a machine learning algorithm to make predictions or decisions as to the runbook providing instructions for transferring the processing of the workload from a first location (e.g., data center 102A) to a second location (e.g., data center 102B). The algorithm iteratively makes predictions on the training data as to the runbook providing instructions for transferring the processing of the workload from a first location (e.g., data center 102A) to a second location (e.g., data center 102B) until the predictions achieve the desired accuracy as determined by an expert. Examples of such learning algorithms include nearest neighbor, Naïve Bayes, decision trees, linear regression, support vector machines, and neural networks.

Disaster recovery system 101 further includes generating engine 202 configured to generate a prediction of the likelihood of a future severe weather event occurring at a first location (e.g., data center 102A) where a workload is running within a user-designated amount of time (e.g., three hours from the current time) that necessitates disaster recovery. In one embodiment, generating engine 202 receives weather forecasting data for that first location (e.g., data center 102A) from weather forecasting system 104. As discussed above, weather forecasting data, as used herein, refers to data used to predict what the atmosphere will be like at a particular location at a future time. For example, weather forecasting data includes the prediction of temperature, humidity, wind speed, wind direction, cloud coverage, air pressure, etc. at a particular location (e.g., data center 102A where a workload is running) at a particular future time (e.g., 5 hours from the current time).

Upon receipt of such weather forecasting data for the first location (e.g., data center 102A), generating engine 202 generates a prediction of the likelihood of a future severe weather event occurring at the first location within a user-designated amount of time that necessitates disaster recovery using the model trained by machine learning engine 201 to predict the likelihood of future severe weather events occurring at the first location using weather forecasting data.

As discussed above, the prediction of the likelihood of a future severe weather event, as used herein, refers to the probability of the future severe weather event occurring at a particular location (e.g., data center 102A where a workload is running), such as at a user-designated amount of time in the future (e.g., three hours from the current time). In one embodiment, such a prediction corresponds to a value, such as a number ranging between 0 and 100, where the higher the value of the number, the greater the likelihood of a severe weather event occurring at the location, which necessitates disaster recovery.

In one embodiment, generating engine 202 determines whether to transfer the processing of the workload being performed at the first location (e.g., data center 102A) to a second location (e.g., data center 102B) based on such a prediction. For example, in one embodiment, such a prediction is compared to a threshold value, which may be user-designated. For instance, if the threshold value is 95, then if the prediction corresponds to a value of 96, indicating that there is a 96% chance of a future severe weather event, such as a tornado, occurring at the first location within a user-designated amount of time (e.g., 3 hours), then generating engine 202 determines to transfer the processing of the workload from the first location (e.g., data center 102A) to the second location (e.g., data center 102B).

Furthermore, in one embodiment, if such a prediction exceeds the threshold value, then generating engine 202 generates a runbook using generative artificial intelligence, which provides instructions for transferring the processing of the workload from the first location (e.g., data center 102A) to the second location (e.g., data center 102B). As discussed above, a runbook, as used herein, includes instructions for transferring the processing of a workload from a first location (e.g., data center 102A) to a second location (e.g., data center 102B).

In one embodiment, generating engine 202 generates such a runbook using the generative artificial intelligence model trained by machine learning engine 201 to make predictions or decisions as to the runbook providing instructions for transferring the processing of the workload from a first location (e.g., data center 102A) to a second location (e.g., data center 102B). In one embodiment, generating engine 202 generates such a runbook by inputting into the trained generative artificial intelligence model the workload to be transferred, the architectures of the data centers at the locations, and the backup operation procedures to be implemented. In one embodiment, information pertaining to the workload to be transferred, the architectures of the data centers at the locations, and the backup operation procedures to be implemented are provided by an expert.

Disaster recovery system 101 additionally includes transferring engine 203 configured to implement the runbook generated by generating engine 202 to transfer the processing of the workload from the first location (e.g., data center 102A) to the second location (e.g., data center 102B) in accordance with the instructions provided by the runbook.

In one embodiment, transferring engine 203 utilizes various software tools for implementing the runbook generated by generating engine 202 to transfer the processing of the workload from the first location (e.g., data center 102A) to the second location (e.g., data center 102B) in accordance with the instructions provided by the runbook, which can include, but are not limited to, Carbonite® Migrate, Astera, Fivetran®, Integrate.io, Mattilion, Stitch, etc.

In this manner, disaster recovery is implemented prior to a disaster event (e.g., tornado) affecting the processing of the workload at the location subject to the disaster event. Such a disaster recovery performed by the principles of the present disclosure is effectively implemented by being proactive (disaster recovery implemented prior to the disaster event actually occurring at the location) as opposed to being reactive to natural calamities (e.g., tornadoes, flash floods, etc.) in a relatively inexpensive manner.

A further description of these and other features is provided below in connection with the discussion of the method for implementing disaster recovery proactively by using weather forecasting data.

Prior to the discussion of the method for implementing disaster recovery proactively by using weather forecasting data, a description of the hardware configuration of disaster recovery system 101 (FIG. 1) is provided below in connection with FIG. 3.

Referring now to FIG. 3, in conjunction with FIG. 1, FIG. 3 illustrates an embodiment of the present disclosure of the hardware configuration of disaster recovery system 101 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code (stored in block 301) involved in performing the disclosed methods, such as implementing disaster recovery proactively by using weather forecasting data. In addition to block 301, computing environment 300 includes, for example, disaster recovery system 101, network 103, such as a wide area network (WAN), end user device (EUD) 302, remote server 303, public cloud 304, and private cloud 305. In this embodiment, disaster recovery system 101 includes processor set 306 (including processing circuitry 307 and cache 308), communication fabric 309, volatile memory 310, persistent storage 311 (including operating system 312 and block 301, as identified above), peripheral device set 313 (including user interface (UI) device set 314, storage 315, and Internet of Things (IoT) sensor set 316), and network module 317. Remote server 303 includes remote database 318. Public cloud 304 includes gateway 319, cloud orchestration module 320, host physical machine set 321, virtual machine set 322, and container set 323.

Disaster recovery system 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 318. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically disaster recovery system 101, to keep the presentation as simple as possible. Disaster recovery system 101 may be located in a cloud, even though it is not shown in a cloud in FIG. 3. On the other hand, disaster recovery system 101 is not required to be in a cloud except to any extent as may be affirmatively indicated.

Processor set 306 includes one, or more, computer processors of any type now known or to be developed in the future. Processing circuitry 307 may be distributed over multiple packages, for example, multiple, coordinated integrated circuit chips. Processing circuitry 307 may implement multiple processor threads and/or multiple processor cores. Cache 308 is memory that is located in the processor chip package(s) and is typically used for data or code that should be available for rapid access by the threads or cores running on processor set 306. Cache memories are typically organized into multiple levels depending upon relative proximity to the processing circuitry. Alternatively, some, or all, of the cache for the processor set may be located “off chip.” In some computing environments, processor set 306 may be designed for working with qubits and performing quantum computing.

Computer readable program instructions are typically loaded onto disaster recovery system 101 to cause a series of operational steps to be performed by processor set 306 of disaster recovery system 101 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 308 and the other storage media discussed below. The program instructions, and associated data, are accessed by processor set 306 to control and direct performance of the disclosed methods. In computing environment 300, at least some of the instructions for performing the disclosed methods may be stored in block 301 in persistent storage 311.

Communication fabric 309 is the signal conduction paths that allow the various components of disaster recovery system 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 310 is any type of volatile memory now known or to be developed in the future. Examples include dynamic type random access memory (RAM) or static type RAM. Typically, the volatile memory is characterized by random access, but this is not required unless affirmatively indicated. In disaster recovery system 101, the volatile memory 310 is located in a single package and is internal to disaster recovery system 101, but, alternatively or additionally, the volatile memory may be distributed over multiple packages and/or located externally with respect to disaster recovery system 101.

Persistent Storage 311 is any form of non-volatile storage for computers that is now known or to be developed in the future. The non-volatility of this storage means that the stored data is maintained regardless of whether power is being supplied to disaster recovery system 101 and/or directly to persistent storage 311. Persistent storage 311 may be a read only memory (ROM), but typically at least a portion of the persistent storage allows writing of data, deletion of data and re-writing of data. Some familiar forms of persistent storage include magnetic disks and solid state storage devices. Operating system 312 may take several forms, such as various known proprietary operating systems or open source Portable Operating System Interface type operating systems that employ a kernel. The code included in block 301 typically includes at least some of the computer code involved in performing the disclosed methods.

Peripheral device set 313 includes the set of peripheral devices of disaster recovery system 101. Data communication connections between the peripheral devices and the other components of disaster recovery system 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 314 may include components such as a display screen, speaker, microphone, wearable devices (such as goggles and smart watches), keyboard, mouse, printer, touchpad, game controllers, and haptic devices. Storage 315 is external storage, such as an external hard drive, or insertable storage, such as an SD card. Storage 315 may be persistent and/or volatile. In some embodiments, storage 315 may take the form of a quantum computing storage device for storing data in the form of qubits. In embodiments where disaster recovery system 101 is required to have a large amount of storage (for example, where disaster recovery system 101 locally stores and manages a large database) then this storage may be provided by peripheral storage devices designed for storing very large amounts of data, such as a storage area network (SAN) that is shared by multiple, geographically distributed computers. IoT sensor set 316 is made up of sensors that can be used in Internet of Things applications. For example, one sensor may be a thermometer and another sensor may be a motion detector.

Network module 317 is the collection of computer software, hardware, and firmware that allows disaster recovery system 101 to communicate with other computers through WAN 103. Network module 317 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 317 are performed on the same physical hardware device. In other embodiments (for example, embodiments that utilize software-defined networking (SDN)), the control functions and the forwarding functions of network module 317 are performed on physically separate devices, such that the control functions manage several different network hardware devices. Computer readable program instructions for performing the disclosed methods can typically be downloaded to disaster recovery system 101 from an external computer or external storage device through a network adapter card or network interface included in network module 317.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 302 is any computer system that is used and controlled by an end user (for example, a customer of an enterprise that operates disaster recovery system 101), and may take any of the forms discussed above in connection with disaster recovery system 101. EUD 302 typically receives helpful and useful data from the operations of disaster recovery system 101. For example, in a hypothetical case where disaster recovery system 101 is designed to provide a recommendation to an end user, this recommendation would typically be communicated from network module 317 of disaster recovery system 101 through WAN 103 to EUD 302. In this way, EUD 302 can display, or otherwise present, the recommendation to an end user. In some embodiments, EUD 302 may be a client device, such as thin client, heavy client, mainframe computer, desktop computer and so on.

Remote server 303 is any computer system that serves at least some data and/or functionality to disaster recovery system 101. Remote server 303 may be controlled and used by the same entity that operates disaster recovery system 101. Remote server 303 represents the machine(s) that collect and store helpful and useful data for use by other computers, such as disaster recovery system 101. For example, in a hypothetical case where disaster recovery system 101 is designed and programmed to provide a recommendation based on historical data, then this historical data may be provided to disaster recovery system 101 from remote database 318 of remote server 303.

Public cloud 304 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 304 is performed by the computer hardware and/or software of cloud orchestration module 320. The computing resources provided by public cloud 304 are typically implemented by virtual computing environments that run on various computers making up the computers of host physical machine set 321, which is the universe of physical computers in and/or available to public cloud 304. The virtual computing environments (VCEs) typically take the form of virtual machines from virtual machine set 322 and/or containers from container set 323. It is understood that these VCEs may be stored as images and may be transferred among and between the various physical machine hosts, either as images or after instantiation of the VCE. Cloud orchestration module 320 manages the transfer and storage of images, deploys new instantiations of VCEs and manages active instantiations of VCE deployments. Gateway 319 is the collection of computer software, hardware, and firmware that allows public cloud 304 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 305 is similar to public cloud 304, except that the computing resources are only available for use by a single enterprise. While private cloud 305 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 304 and private cloud 305 are both part of a larger hybrid cloud.

Block 301 further includes the software components discussed above in connection with FIG. 2 to implement disaster recovery proactively by using weather forecasting data. In one embodiment, such components may be implemented in hardware. The functions discussed above performed by such components are not generic computer functions. As a result, disaster recovery system 101 is a particular machine that is the result of implementing specific, non-generic computer functions.

In one embodiment, the functionality of such software components of disaster recovery system 101, including the functionality for implementing disaster recovery proactively by using weather forecasting data, may be embodied in an application specific integrated circuit.

As stated above, disaster recovery is the process by which an organization anticipates and addresses technology-related disasters. For example, disaster recovery is the process of preparing for and recovering from any event that prevents a workload or system from fulfilling its business objectives in its primary deployed location, such as power outages, or natural events (e.g., storms, hurricanes, heat waves, etc.). A plan, referred to as a “disaster recovery plan,” helps organizations respond promptly to disruptive events and provides key benefits. For example, such a disaster recovery plan ensures business continuity. When a disaster strikes, it can be detrimental to all aspects of the business and is often costly. It also interrupts normal business operations, as the team's productivity is reduced due to limited access to tools they require to work. Currently, such disaster recovery plans focus on reacting to disaster events, such as power outages and natural events (e.g., storms, hurricanes, heat waves, etc.). For example, once such a disaster event occurs, then a plan is enacted, such as backing up the workload being processed by the data center affected by the disaster event. Unfortunately, by being reactive, data may be lost at the data center subject to the disaster event prior to backing up such data. In such an approach, the recovery time objective is very high. The recovery time objective is a metric that determines the maximum amount of time that passes before disaster recovery is completed. Furthermore, in such an approach, the recovery point objective is very high. The recovery point objective is the maximum amount of time acceptable for data loss after a disaster. Alternatively, a disaster recovery plan may focus on replicating the data center as well as the workloads running at such a data center. When one of these data centers is subject to a disaster event, the other data center may still be operational and continue to process the workloads. However, such an architecture (replicating workloads at a second data center) is extremely expensive to implement. Unfortunately, such current approaches to disaster recovery are reactive (i.e., in response to the disaster event which may result in the loss of data) or expensive to implement.

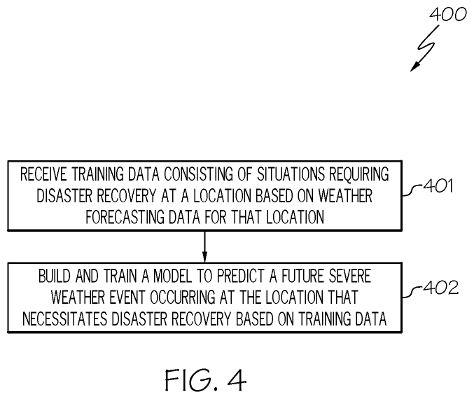

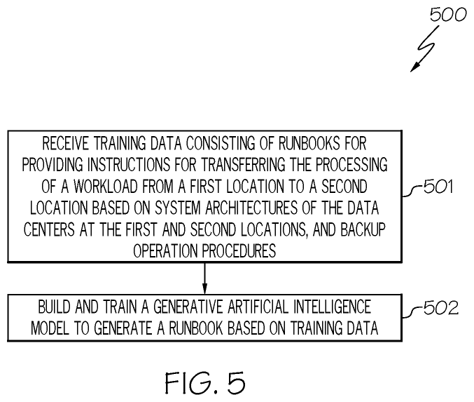

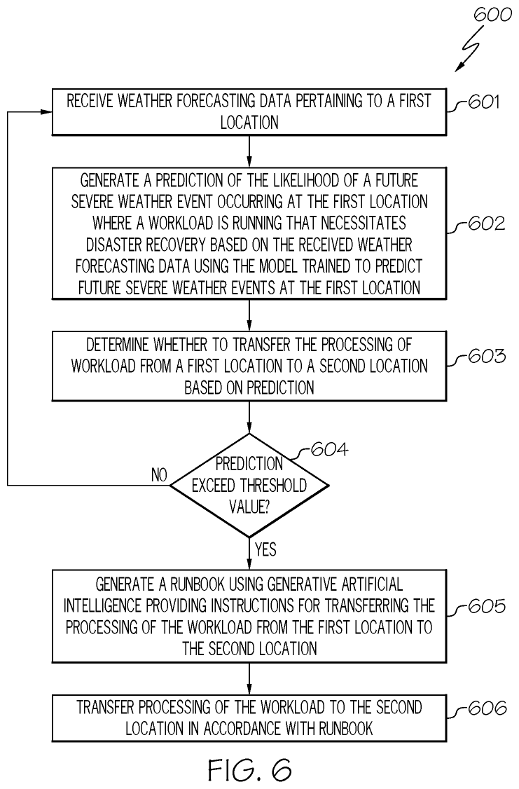

The embodiments of the present disclosure provide a means for more effectively implementing disaster recovery due to unforeseen circumstances, such as natural calamities (e.g., hurricanes, tornados, heat waves, etc.), without being reactive to such unforeseen circumstances and in a relatively inexpensive manner as discussed below in connection with FIGS. 4-6. FIG. 4 is a flowchart of a method for training a model for predicting the likelihood of a future severe weather event occurring at a location where a workload is running that necessitates disaster recovery. FIG. 5 is a flowchart of a method for training a generative artificial intelligence model for generating a runbook providing instructions for transferring the processing of the workload from one location to another location. FIG. 6 is a flowchart of a method for implementing disaster recovery proactively by using weather forecasting data.

As stated above, FIG. 4 is a flowchart of a method 400 for training a model for predicting the likelihood of a future severe weather event occurring at a location where a workload is running that necessitates disaster recovery in accordance with an embodiment of the present disclosure.

Referring to FIG. 4, in conjunction with FIGS. 1-3, in operation 401, machine learning engine 201 of disaster recovery system 101 receives training data consisting of situations requiring disaster recovery at a location (e.g., data center 102A) based on weather forecasting data for that location which is received from weather forecasting system 104.

In operation 402, machine learning engine 201 of disaster recovery system 101 builds and trains a model to predict a future severe weather event occurring at the location (e.g., data center 102A) that necessitates disaster recovery based on the training data.

As discussed above, disaster recovery, as used herein, is the process of protecting data from disasters, such as a natural disaster (e.g., storm).

Furthermore, a “severe weather event,” as used herein, refers to any dangerous meteorological phenomenon with the potential to cause damage, serious disruption, or loss of human life at a location, such as at a data center where a workload is running. Examples of severe weather events can include, but are not limited to, tornados, straight-line winds, flash floods, hailstorms, hurricanes, heat waves, etc.

In one embodiment, based on current weather forecasting data (weather forecasting data received from weather forecasting system 104) at a location (e.g., data center 102A where a workload is running), the model is trained to predict a likelihood of a future severe weather event occurring at the location that necessitates disaster recovery. The prediction of the likelihood of a future severe weather event, as used herein, refers to the probability of the future severe weather event occurring at a particular location (e.g., data center 102A where a workload is running), such as at a user-designated amount of time in the future (e.g., three hours from the current time). In one embodiment, such a prediction corresponds to a value, such as a number ranging between 0 and 100, where the higher the value of the number, the greater the likelihood of a severe weather event occurring at the location, which necessitates disaster recovery.

In one embodiment, machine learning engine 201 builds and trains a model to predict a future severe weather event occurring at a location (e.g., data center 102A) that necessitates disaster recovery based on a sample data set that includes situations requiring disaster recovery at a location based on weather forecasting data for that location. Weather forecasting data, as used herein, refers to data used to predict what the atmosphere will be like at a particular location at a future time. For example, weather forecasting data includes the prediction of temperature, humidity, wind speed, wind direction, cloud coverage, air pressure, etc. at a particular location (e.g., data center 102A where a workload is running) at a particular future time (e.g., 5 hours from the current time).

Such a sample data set may be stored in a data structure (e.g., table) residing within the storage device (e.g., storage device 311, 315) of disaster recovery system 101. In one embodiment, such a data structure is populated by an expert.

Furthermore, in one embodiment, the sample data set discussed above is referred to herein as the “training data,” which is used by a machine learning algorithm to make predictions or decisions as to the likelihood of a future severe weather event occurring at the location that necessitates disaster recovery. The algorithm iteratively makes predictions on the training data as to the likelihood of a future severe weather event occurring at the location that necessitates disaster recovery until the predictions achieve the desired accuracy as determined by an expert. Examples of such learning algorithms include nearest neighbor, Naïve Bayes, decision trees, linear regression, support vector machines, and neural networks.

In addition to training a model to predict the likelihood of a future severe weather event occurring at a location (e.g., data center 102A) that necessitates disaster recovery, a generative artificial intelligence model may be trained to generate a runbook to provide instructions for transferring the processing of the workload from a first location (e.g., data center 102A) to a second location (e.g., data center 102B) when the prediction of the likelihood of a future severe weather event occurring at the first location (e.g., data center 102A) to necessitate disaster recovery exceeds a threshold value. The training of such a generative artificial intelligence model is discussed below in connection with FIG. 5.

FIG. 5 is a flowchart of a method 500 for training a generative artificial intelligence model for generating a runbook providing instructions for transferring the processing of the workload from one location to another location in accordance with an embodiment of the present disclosure.

Referring to FIG. 5, in conjunction with FIGS. 1-3, in operation 501, machine learning engine 201 of disaster recovery system 101 receives training data consisting of runbooks for providing instructions for transferring the processing of a workload from a first location to a second location based on the system architectures of the data centers at the first and second locations, and backup operation procedures.

As discussed above, a runbook, as used herein, includes instructions for transferring the processing of a workload from a first location (e.g., data center 102A) to a second location (e.g., data center 102B).

Furthermore, the system architecture of a data center, as used herein, refers to the architectural design that establishes connections between components, such as switches and servers. Backup operation procedures, as used herein, refer to the process of creating and storing copies of data that can be used to protect organizations against data loss. Backup operation procedures ensure that essential data processing operational tasks can be conducted after the disruption, such as a disaster event (e.g., tornado).

In operation 502, machine learning engine 201 of disaster recovery system 101 builds and trains a generative artificial intelligence model to generate a runbook providing instructions for transferring the processing of the workload from a first location (e.g., data center 102A) to a second location (e.g., data center 102B) based on the training data.

As stated above, in situations in which the likelihood of a future severe weather event occurring at the first location that necessitates disaster recovery exceeds a threshold value, which may be user-designated, a runbook is generated using generative artificial intelligence to provide instructions for transferring the processing of the workload from the first location (e.g., data center 102A) to a second location (e.g., data center 102B).

In one embodiment, such a runbook includes details regarding the migration of the workload from the first location to the second location, such as utilizing on-premise tools if the workload is to be migrated within the network of a medium or large enterprise installation or cloud-based tools if the workload is to be migrated from the first location to the cloud and then to the second location.

In one embodiment, such a runbook includes post-migration testing.

In one embodiment, such a runbook includes a listing of the particular folders (e.g., virtual machines folders) to store data for the workload, which are moved to the new datastore at the new location (e.g., data center).

In one embodiment, such a runbook includes the files, such as OVA (Open Virtual Appliance) and OVF (Open Virtualization Format), pertaining to the workload being processed at the first location to be transferred to the second location.

In one embodiment, machine learning engine 201 builds and trains a generative artificial intelligence model to generate a runbook providing instructions for transferring the processing of the workload from a first location (e.g., data center 102A) to a second location (e.g., data center 102B) based on a sample data set that includes instructions for transferring the processing of various workloads from various locations, including the system architectures (e.g., meshwork, three-tier or multi-tier model, mesh point of delivery, super spine mesh, components, such as switches and servers, etc.) of the data centers at such locations, and backup operation procedures.

In one embodiment, the sample data set discussed above may be stored in a data structure (e.g., table) residing within the storage device (e.g., storage device 311, 315) of disaster recovery system 101. In one embodiment, such a data structure is populated by an expert.

Upon training the generative artificial intelligence model to generate a runbook providing instructions for transferring the processing of the workload from a first location (e.g., data center 102A) to a second location (e.g., data center 102B), the trained generative artificial intelligence model generates the appropriate runbook based on the workload to be transferred, the architectures of the data centers at the locations, and the backup operation procedures to be implemented. In one embodiment, information pertaining to the workload to be transferred, the architectures of the data centers at the locations, and the backup operation procedures to be implemented are provided by an expert.

Furthermore, in one embodiment, the sample data set discussed above is referred to herein as the “training data,” which is used by a machine learning algorithm to make predictions or decisions as to the runbook providing instructions for transferring the processing of the workload from a first location (e.g., data center 102A) to a second location (e.g., data center 102B). The algorithm iteratively makes predictions on the training data as to the runbook providing instructions for transferring the processing of the workload from a first location (e.g., data center 102A) to a second location (e.g., data center 102B) until the predictions achieve the desired accuracy as determined by an expert. Examples of such learning algorithms include nearest neighbor, Naïve Bayes, decision trees, linear regression, support vector machines, and neural networks.

Upon training the model to predict the likelihood of a future severe weather event occurring at a location (e.g., data center 102A) that necessitates disaster recovery as well as training a generative artificial intelligence model to generate a runbook to provide instructions for transferring the processing of the workload from a first location (e.g., data center 102A) to a second location (e.g., data center 102B) when the prediction of the likelihood of a future severe weather event occurring at the first location (e.g., data center 102A) that necessitates disaster recovery exceeds a threshold value, such trained models may be utilized to implement disaster recovery proactively by using weather forecasting data as discussed below in connection with FIG. 6.

FIG. 6 is a flowchart of a method 600 for implementing disaster recovery proactively by using weather forecasting data in accordance with an embodiment of the present disclosure.

Referring to FIG. 6, in conjunction with FIGS. 1-5, in operation 601, generating engine 202 of disaster recovery system 101 receives weather forecasting data pertaining to a first location (e.g., data center 102A) from weather forecasting system 104.

As discussed above, weather forecasting data, as used herein, refers to data used to predict what the atmosphere will be like at a particular location at a future time. For example, weather forecasting data includes the prediction of temperature, humidity, wind speed, wind direction, cloud coverage, air pressure, etc. at a particular location (e.g., data center 102A where a workload is running) at a particular future time (e.g., 5 hours from the current time).

Upon receipt of such weather forecasting data for the first location (e.g., data center 102A), in operation 602, generating engine 202 of disaster recovery system 101 generates a prediction of the likelihood of a future severe weather event occurring at the first location where a workload is running within a user-designated amount of time (e.g., 3 hours from the current time) that necessitates disaster recovery based on the received weather forecasting data using the model trained by machine learning engine 201 to predict the likelihood of future severe weather events occurring at the first location using weather forecasting data.

As stated above, the prediction of the likelihood of a future severe weather event, as used herein, refers to the probability of the future severe weather event occurring at a particular location (e.g., data center 102A where a workload is running), such as at a user-designated amount of time in the future (e.g., three hours from the current time). In one embodiment, such a prediction corresponds to a value, such as a number ranging between 0 and 100, where the higher the value of the number, the greater the likelihood of a severe weather event occurring at the location, which necessitates disaster recovery.

In operation 603, generating engine 202 of disaster recovery system 101 determines whether to transfer the processing of the workload being performed at the first location (e.g., data center 102A) to a second location (e.g., data center 102B) based on such a prediction. For example, in one embodiment, such a prediction is compared to a threshold value, which may be user-designated. For instance, if the threshold value is 95, then if the prediction corresponds to a value of 96, indicating that there is a 96% chance of a future severe weather event, such as a tornado, occurring at the first location within a user-designated amount of time (e.g., 3 hours), then generating engine 202 determines to transfer the processing of the workload from the first location (e.g., data center 102A) to the second location (e.g., data center 102B).

In operation 604, generating engine 202 of disaster recovery system 101 determines if the prediction exceeds a threshold value, which may be user-designated.

If the prediction does not exceed the threshold value, then generating engine 202 of disaster recovery system 101 receives updated weather forecasting data pertaining to the first location (e.g., data center 102A) from weather forecasting system 104 in operation 601.

If, however, the prediction exceeds the threshold value, then, in operation 605, generating engine 202 of disaster recovery system 101 generates a runbook using generative artificial intelligence, which provides instructions for transferring the processing of the workload from the first location (e.g., data center 102A) to the second location (e.g., data center 102B).

As discussed above, a runbook, as used herein, includes instructions for transferring the processing of a workload from a first location (e.g., data center 102A) to a second location (e.g., data center 102B).

Furthermore, as stated above, in one embodiment, generating engine 202 generates such a runbook using the generative artificial intelligence model trained by machine learning engine 201 to make predictions or decisions as to the runbook providing instructions for transferring the processing of the workload from a first location (e.g., data center 102A) to a second location (e.g., data center 102B). In one embodiment, generating engine 202 generates such a runbook by inputting into the trained generative artificial intelligence model the workload to be transferred, the architectures of the data centers at the locations, and the backup operation procedures to be implemented. In one embodiment, information pertaining to the workload to be transferred, the architectures of the data centers at the locations, and the backup operation procedures to be implemented are provided by an expert.

In operation 606, transferring engine 203 of disaster recovery system 101 implements the runbook generated by generating engine 202 to transfer the processing of the workload from the first location (e.g., data center 102A) to the second location (e.g., data center 102B) in accordance with the instructions provided by the runbook.

As stated above, in one embodiment, transferring engine 203 utilizes various software tools for implementing the runbook generated by generating engine 202 to transfer the processing of the workload from the first location (e.g., data center 102A) to the second location (e.g., data center 102B) in accordance with the instructions provided by the runbook, which can include, but are not limited to, Carbonite® Migrate, Astera, Fivetran®, Integrate.io, Mattilion, Stitch, etc.

In this manner, disaster recovery is implemented prior to a disaster event (e.g., tornado) affecting the processing of the workload at the location subject to the disaster event. Such a disaster recovery performed by the principles of the present disclosure is effectively implemented by being proactive (disaster recovery implemented prior to the disaster event actually occurring at the location) as opposed to being reactive to natural calamities (e.g., tornadoes, flash floods, etc.) in a relatively inexpensive manner.

Furthermore, the principles of the present disclosure improve the technology or technical field involving disaster recovery.

As discussed above, disaster recovery is the process by which an organization anticipates and addresses technology-related disasters. For example, disaster recovery is the process of preparing for and recovering from any event that prevents a workload or system from fulfilling its business objectives in its primary deployed location, such as power outages, or natural events (e.g., storms, hurricanes, heat waves, etc.). A plan, referred to as a “disaster recovery plan,” helps organizations respond promptly to disruptive events and provides key benefits. For example, such a disaster recovery plan ensures business continuity. When a disaster strikes, it can be detrimental to all aspects of the business and is often costly. It also interrupts normal business operations, as the team's productivity is reduced due to limited access to tools they require to work. Currently, such disaster recovery plans focus on reacting to disaster events, such as power outages and natural events (e.g., storms, hurricanes, heat waves, etc.). For example, once such a disaster event occurs, then a plan is enacted, such as backing up the workload being processed by the data center affected by the disaster event. Unfortunately, by being reactive, data may be lost at the data center subject to the disaster event prior to backing up such data. In such an approach, the recovery time objective is very high. The recovery time objective is a metric that determines the maximum amount of time that passes before disaster recovery is completed. Furthermore, in such an approach, the recovery point objective is very high. The recovery point objective is the maximum amount of time acceptable for data loss after a disaster. Alternatively, a disaster recovery plan may focus on replicating the data center as well as the workloads running at such a data center. When one of these data centers is subject to a disaster event, the other data center may still be operational and continue to process the workloads. However, such an architecture (replicating workloads at a second data center) is extremely expensive to implement. Unfortunately, such current approaches to disaster recovery are reactive (i.e., in response to the disaster event which may result in the loss of data) or expensive to implement.

Embodiments of the present disclosure improve such technology by receiving weather forecasting data for a first location (e.g., data center). Weather forecasting data, as used herein, refers to data used to predict what the atmosphere will be like at a particular location (e.g., first location) at a future time. For example, weather forecasting data includes the prediction of temperature, humidity, wind speed, wind direction, cloud coverage, air pressure, etc. at a particular location (e.g., data center where a workload is running) at a particular future time (e.g., 5 hours from the current time). A prediction of the likelihood of the future severe weather event occurring at the first location where a workload is running within a user-designated amount of time (e.g., 3 hours from the current time) that necessitates disaster recovery is generated based on the received weather forecasting data using a model trained to predict the likelihood of future severe weather events occurring at the first location using weather forecasting data. The prediction of the likelihood of a future severe weather event, as used herein, refers to the probability of the future severe weather event occurring at a particular location (e.g., data center where a workload is running). In one embodiment, such a prediction corresponds to a value, such as a number ranging between 0 and 100. A determination is then made as to whether to implement disaster recovery, which involves the transfer of the processing of the workload performed at the first location to a second location based on such a prediction. For example, in one embodiment, such a prediction is compared to a threshold value, which may be user-designated. For instance, if the threshold value is 95, then if the prediction corresponds to a value of 96, indicating that there is a 96% chance of a future severe weather event, such as a tornado, occurring at the first location within a user-designated amount of time (e.g., 3 hours), then disaster recovery is implemented, such as transferring the processing of the workload from the first location to the second location. In this manner, disaster recovery is effectively implemented by being proactive (disaster recovery implemented prior to the disaster event actually occurring at the location) as opposed to being reactive to natural calamities (e.g., tornadoes, flash floods, etc.) in a relatively inexpensive manner. Furthermore, in this manner, there is an improvement in the technical field involving disaster recovery.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for implementing disaster recovery, the method comprising:
receiving weather forecasting data pertaining to a first location;
generating a prediction of a likelihood of a future severe weather event occurring at the first location where a workload is running that necessitates disaster recovery based on the received weather forecasting data using a model trained to predict future severe weather events at the first location; and
determining whether to transfer processing of the workload from the first location to a second location based on the prediction.

2. The method as recited in claim 1, wherein the prediction corresponds to a value, wherein the processing of the workload is transferred from the first location to the second location in response to the prediction exceeding a threshold value.

3. The method as recited in claim 1, wherein the first location corresponds to a first data center, wherein the second location corresponds to a second data center.

4. The method as recited in claim 1, wherein the prediction corresponds to a value, wherein the method further comprises:
generating a runbook using generative artificial intelligence in response to the prediction exceeding a threshold value, wherein the runbook comprises instructions for transferring the processing of the workload from the first location to the second location; and
transferring the processing of the workload from the first location to the second location in accordance with the runbook.

5. The method as recited in claim 1 further comprising:
training a generative artificial intelligence model to generate a runbook providing instructions for transferring the processing of the workload from the first location to the second location based on system architectures of data centers located at the first and second locations, and backup operations procedures.

6. The method as recited in claim 1 further comprising:
training the model to predict future severe weather events occurring at the first location that necessitates disaster recovery based on training data consisting of situations requiring disaster recovery at the first location based on weather forecasting data for the first location.

7. The method as recited in claim 1, wherein the weather forecasting data comprises a prediction of one or more of the following to occur at a future time at the first location from the group consisting of: temperature, precipitation, humidity, wind speed, wind direction, cloud coverage, and air pressure.

8. A computer program product for implementing disaster recovery, the computer program product comprising one or more computer readable storage mediums having program code embodied therewith, the program code comprising programming instructions for:
receiving weather forecasting data pertaining to a first location;
generating a prediction of a likelihood of a future severe weather event occurring at the first location where a workload is running that necessitates disaster recovery based on the received weather forecasting data using a model trained to predict future severe weather events at the first location; and
determining whether to transfer processing of the workload from the first location to a second location based on the prediction.

9. The computer program product as recited in claim 8, wherein the prediction corresponds to a value, wherein the processing of the workload is transferred from the first location to the second location in response to the prediction exceeding a threshold value.

10. The computer program product as recited in claim 8, wherein the first location corresponds to a first data center, wherein the second location corresponds to a second data center.

11. The computer program product as recited in claim 8, wherein the prediction corresponds to a value, wherein the program code further comprises the programming instructions for:
generating a runbook using generative artificial intelligence in response to the prediction exceeding a threshold value, wherein the runbook comprises instructions for transferring the processing of the workload from the first location to the second location; and
transferring the processing of the workload from the first location to the second location in accordance with the runbook.

12. The computer program product as recited in claim 8, wherein the program code further comprises the programming instructions for:
training a generative artificial intelligence model to generate a runbook providing instructions for transferring the processing of the workload from the first location to the second location based on system architectures of data centers located at the first and second locations, and backup operations procedures.

13. The computer program product as recited in claim 8, wherein the program code further comprises the programming instructions for:
training the model to predict future severe weather events occurring at the first location that necessitates disaster recovery based on training data consisting of situations requiring disaster recovery at the first location based on weather forecasting data for the first location.

14. The computer program product as recited in claim 8, wherein the weather forecasting data comprises a prediction of one or more of the following to occur at a future time at the first location from the group consisting of: temperature, precipitation, humidity, wind speed, wind direction, cloud coverage, and air pressure.

15. A system, comprising:
a memory for storing a computer program for implementing disaster recovery; and
a processor connected to the memory, wherein the processor is configured to execute program instructions of the computer program comprising:
receiving weather forecasting data pertaining to a first location;
generating a prediction of a likelihood of a future severe weather event occurring at the first location where a workload is running that necessitates disaster recovery based on the received weather forecasting data using a model trained to predict future severe weather events at the first location; and
determining whether to transfer processing of the workload from the first location to a second location based on the prediction.

16. The system as recited in claim 15, wherein the prediction corresponds to a value, wherein the processing of the workload is transferred from the first location to the second location in response to the prediction exceeding a threshold value.

17. The system as recited in claim 15, wherein the first location corresponds to a first data center, wherein the second location corresponds to a second data center.

18. The system as recited in claim 15, wherein the prediction corresponds to a value, wherein the program instructions of the computer program further comprise:
generating a runbook using generative artificial intelligence in response to the prediction exceeding a threshold value, wherein the runbook comprises instructions for transferring the processing of the workload from the first location to the second location; and
transferring the processing of the workload from the first location to the second location in accordance with the runbook.

19. The system as recited in claim 15, wherein the program instructions of the computer program further comprise:
training a generative artificial intelligence model to generate a runbook providing instructions for transferring the processing of the workload from the first location to the second location based on system architectures of data centers located at the first and second locations, and backup operations procedures.

20. The system as recited in claim 15, wherein the program instructions of the computer program further comprise:
training the model to predict future severe weather events occurring at the first location that necessitates disaster recovery based on training data consisting of situations requiring disaster recovery at the first location based on weather forecasting data for the first location.
